(19) United States
(12) Patent Application Publication
(10) Pub. No.: US 2012/0054316 A1
(43) Pub. Date: Mar. 1, 2012

(54) TCP MULTIPLEXING OVER A PROXY

(75) Inventors: Kevin Piazza, Santa Ana, CA (US); Weichin Lo Hsu, Irvine, CA (US); Basant Verma, Bangalore (IN)

(73) Assignee: CANON KABUSHIKI KAISHA, Tokyo (JP)

(21) Appl. No.: 12/874,143

(22) Filed: Sep. 1, 2010

(51) Int. Cl. G06F 15/16

(52) U.S. Cl. 709/219

(57) ABSTRACT

A proxy consolidates multiple TCP requests from clients into one TCP connection between a proxy and server. A persistent TCP connection is opened between the proxy and server, and a connection request is received from a client at the proxy. A unique identifier is registered for the client, and the server is signaled over the persistent connection to register the unique identifier. A client connection is established between the client and proxy responsive to the connection request. A content request is received from the client over the client connection. The unique identifier is prepended to the content request, the prepended content request is forwarded to the server, and prepended content is received from the server. The identifier and the content are extracted from the prepended content, and a client and a client connection are identified that correspond to the extracted identifier. The extracted content is returned to the corresponding client.

### FIELD

The invention relates to the field of TCP multiplexing over a proxy, and more particularly relates to TCP multiplexing over a proxy which consolidates multiple TCP requests from clients into one TCP connection between the proxy and a server.

### BACKGROUND

Transmission Control Protocol (TCP) is one of the main protocols in TCP/IP networks. Whereas the IP protocol deals only with packets, TCP enables two hosts to establish a connection and exchange streams of data.

It is common for applications and devices to communicate using the TCP protocol. Some higher-level protocols, such as Hypertext Transfer Protocol (HTTP), often require that multiple TCP connections be established during the communication process. For example, an application may initially contact a device's HTTP server on port 80. The HTTP server may respond to the application by having it retrieve the requested data from various ports, such as 81, 82 or 83. In this example, even though the original communication started on a known port (i.e., port 80), subsequent communication resulted in establishing other connections.

Furthermore, applications and devices often communicate through a firewall. The HTTP port (e.g., port 80) may be open for communication by firewalls, thus enabling at least one point of contact between the applications and devices. Applications and devices can communicate data through a firewall by sending TCP data over an HTTP connection. Once an HTTP connection is established, the data is typically sent as a byte stream, which is not in HTTP format.

### SUMMARY

One problem with HTTP is that establishing an HTTP connection is typically a time-consuming process. Thus, for an application tunneling HTTP data, communication typically slows down when an HTTP connection is established every time a new port is needed. The above problem can be further affected when applications and devices are communicating through a firewall, and can lead to scalability issues. Of course, such slow down of communication is not limited to HTTP, and can apply to other protocols.

The present disclosure addresses the foregoing problems. Disclosed embodiments describe devices and methods for TCP multiplexing over a proxy, wherein the proxy consolidates multiple TCP requests from clients into one TCP connection between the proxy and a server.

In an example embodiment described herein, TCP multiplexing is performed over a proxy, wherein the proxy consolidates multiple TCP requests from clients into one TCP connection between the proxy and a server. A persistent TCP connection is opened between the proxy and the server, and a connection request is received from a client at the proxy, wherein the connection request comprises a request for establishment of a new connection between the client and the server. A unique identifier is registered for the client, and the server is signaled over the persistent connection to register the unique identifier for the client. A client connection is established between the client and the proxy responsive to the connection request, and a content request is received from the client over the client connection, wherein the content request comprises a request for content on the server. The unique identifier for the client is prepended to the content request, the prepended content request is forwarded to the server over the persistent connection, and prepended content is received from the server over the persistent connection, wherein the prepended content includes an identifier prepended to content. The identifier and the content are extracted from the prepended content, and a client and a client connection are identified that correspond to the extracted identifier. The extracted content is returned to the client that corresponds to the extracted identifier over the client connection.

The opening of the persistent TCP connection between the proxy and the server can comprise exchanging an ECHO command between the server and the proxy. The server and the proxy can be separated by a firewall which exposes the proxy to incoming connection requests and which shields the server from such requests, and the opening of the persistent TCP connection between the proxy and the server can comprise receipt of an ECHO command from the server and a response thereto from the proxy. The persistent connection can be closed between the server and the proxy.

A command sequence can be composed which includes a command to register the client and the unique identifier of the client, and the signaling of the server can comprise sending the command sequence over the persistent connection to the server. A command sequence can be composed which includes a command to request content, the unique identifier of the client, and the content request from the client, and the forwarding of the prepended content request can comprise sending the command sequence to the server.

A request can be received from the client to close the client connection. Responsive to the request from the client to close the client connection, the client and its unique identifier can be unregistered, and the server can be signaled over the persistent connection to unregister the unique identifier.

In a further example embodiment, a server communicates with a proxy, wherein the proxy consolidates multiple TCP requests from clients into one TCP connection between the proxy and the server. A persistent TCP connection is opened between the proxy and the server, and a signal is received over the persistent connection to register a unique identifier for a client, based on a connection request from the client at the proxy, wherein the connection request comprises a request for establishment of a new connection between the client and the server. The unique identifier for the client is registered based on the signal. A content request is received from the proxy over the persistent connection, wherein a client connection is established between the client and the proxy responsive to the connection request, the content request is received by the proxy from the client over the client connection, the content request comprises a request for content on the server, and the content request is prepended with the unique identifier for the client. Content is obtained based on the prepended content request, and an identifier is prepended to the obtained content. The prepended content is sent to the proxy over the persistent connection, for extraction of the identifier and the content from the prepended content, identification of a client and a client connection corresponding to the extracted identifier, and return of the extracted content to the client that corresponds to the extracted identifier over the client connection.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a depiction of a network environment which provides for TCP multiplexing according to an example embodiment.

FIG. 2 is a block diagram depicting the internal architecture of the server shown in FIG. 1, according to an example embodiment.

FIG. 3 is a block diagram depicting the internal architecture of the proxy shown in FIG. 1, according to an example embodiment.

FIG. 4 is a diagram illustrating an example of network communication between a device agent host and a device proxy host according to an example embodiment.

FIG. 5 is a sequence diagram illustrating different sequences for TCP multiplexing over a proxy according to an example embodiment.

FIG. 6 is a flow diagram illustrating TCP multiplexing over a proxy according to an example embodiment.

### DETAILED DESCRIPTION

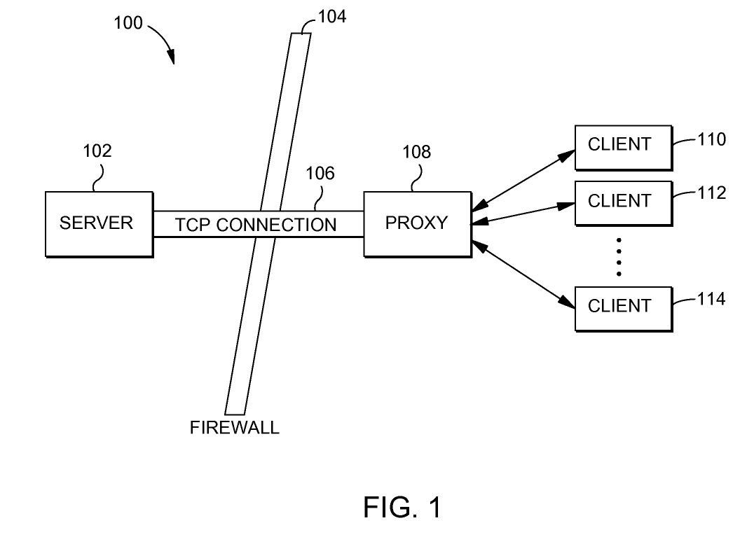

FIG. 1 is a depiction of a network environment which provides for TCP multiplexing according to an example embodiment. Network environment 100 provides for TCP multiplexing over a proxy 108. More particularly, proxy 108 receives multiple TCP requests from clients 110, 112 and 114. Proxy 108 consolidates the multiple TCP requests into one TCP connection 106 between proxy 108 and a server 102. Server 102 and proxy 108 can be separated by a firewall 104, which exposes the proxy to incoming connection requests from clients 110 to 114 and which shields server 102 from such requests.

TCP connection 106 can be a persistent connection which is opened between proxy 108 and server 102. A connection request can be opened by any of clients 110 to 114 at proxy 108, where the connection request includes a request for establishment of a new connection between that client and server 102. A unique identifier can be registered for the client (e.g., client 110 to 114), and server 102 can be signaled over TCP connection 106 to register the unique identifier for the client. A client connection can be established between the client and proxy 108 responsive to the connection request. A content request can be received from the client over client connection, where the content request includes a request for content on server 102. The unique identifier for the client can be prepended to the content request, and the prepended content request can be forwarded to server 102 over TCP connection 106. The prepended content can be received from server 102 over TCP connection 106, where the prepended content includes an identifier prepended to content. The identifier and the content can be extracted from the prepended content, and a client (e.g., client 110 to 114) and a client connection can be identified that correspond to the extracted identifier. The extracted content can be returned to the client that corresponds to the extracted identifier over the client connection.

The opening of a persistent TCP connection 106 between proxy 108 and server 102 can include exchanging an ECHO command between server 102 and proxy 108. As noted above, server 102 and proxy 108 can be separated by firewall 104, which exposes proxy 108 to incoming connection requests and which shields server 102 from such requests. The opening of the persistent TCP connection 106 between proxy 108 and server 102 can include receipt of an ECHO command from server 102 and a response thereto from proxy 108. TCP connection 106 can be closed between server 102 and proxy 108.

A command sequence can be composed which includes a command to register the client (e.g., client 110 to 114) and the unique identifier of the client, and the signaling of server 102 can include sending the command sequence over TCP connection 106 to server 102. A command sequence can be composed which includes a command to request content, the unique identifier of the client, and the content request from the client, and the forwarding of the prepended content request can include sending the command sequence to server 102.

A request can be received from the client (e.g., client 110 to 114) to close the client connection. Responsive to the request from the client to close the client connection, the client and its unique identifier can be unregistered, and server 102 can be signaled over TCP connection 106 to unregister the unique identifier.

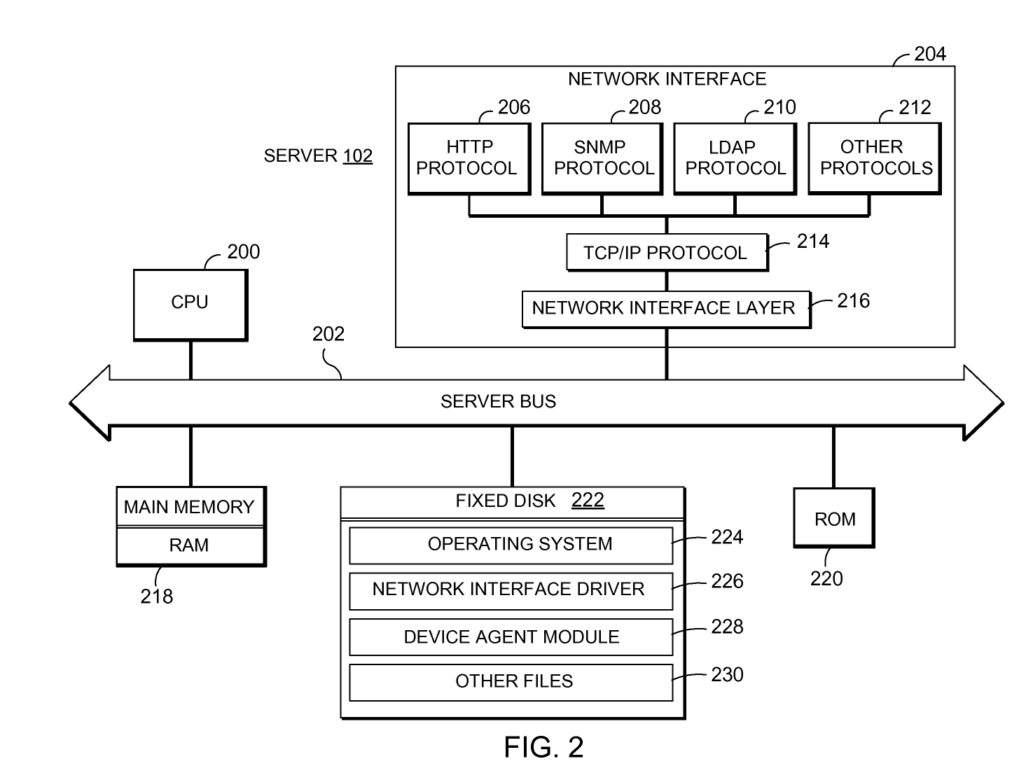

FIG. 2 is a block diagram depicting the internal architecture of the server shown in FIG. 1, according to an example embodiment. Server 102 can correspond to a server for a device (e.g., HTTP server). Such a server will be described in greater detail below with reference to a device agent, which is a device-side component of a port forwarding system to help broker communication between a device and a client (e.g., clients 110 to 114). The device agent can communicate with proxy 108, and can reside on the device.

In this regard, a port forwarding system can refer to a single device proxy and one or more assigned device agents working together to manage port forwarding tunnels. Further, port forwarding can refer to when traffic from a network port is passed to another network port.

In addition, port forwarding can refer to when an internal node must initiate a port forwarding session with an external node due to firewall restrictions. Once the session is established, the external node may forward network traffic to the internal node. It should be noted that such forwarding can also be referred to as “reverse” port forwarding.

As can be seen in FIG. 2, server 102 can include a central processing unit (“CPU”) 200 such as a programmable microprocessor which can be interfaced to server bus 202. Also coupled to server bus 202 can be a network interface 204 for interfacing to proxy 108 or clients 110 to 114. In addition, random access memory (“RAM”) 218, fixed disk 222, and read-only memory (“ROM”) 220 can be coupled to server bus 202. RAM 218 can interface to server bus 202 to provide CPU 200 with access to memory storage, thereby acting as a main run-time memory for CPU 200. In particular, when executing stored program instruction sequences, CPU 200 can load those instruction sequences from fixed disk 222 (or other memory media) into RAM 218 and execute those stored program instruction sequences out of RAM 218. It should also be recognized that standard disk-swapping techniques can allow segment of memory to be swapped to and from RAM 218 and fixed disk 222.

ROM 220 can store invariant instruction sequences, such as start-up instruction sequences for CPU 200 or basic input/output operating system (“BIOS”) sequences for the operation of network devices which may be attached to server 102. Network interface 204 can contain several modules to provide the appropriate interface functionality for server 102. For example, network interface 204 can contain network interface layer 216, which is typically a low-level protocol layer. TCP/IP layer 214 can be provided above network interface layer 216 for communicating over a network with proxy 108 or clients 110 to 114 via TCP/IP. Other protocols 212 can also be provided to allow server 102 to communicate over the network using other conventional protocols. In this regard, it is possible for HTTP protocol 206, SNMP protocol 208, and LDAP protocol 210 to be provided in network interface 204 for allowing server 102 to communicate to over a network using HTTP, SNMP and LDAP, respectively. However, it should be noted that HTTP, SNMP and LDAP protocols, along with other conventional protocols, can instead be provided by operating system 224. The foregoing protocols can allow for server 102 to communicate over a network (e.g., the Internet) with other devices.

Fixed disk 222 is one example of a computer-readable medium that stores program instruction sequences executable by CPU 200 so as to constitute operating system 224, network interface driver 226, device agent module 228 and other files 230. Operating system 224 can be an operating system such as DOS, Windows 95, Windows 98, Windows 2000, Windows XP, Windows 7, Windows NT, UNIX, or other such operating system. Network interface driver 226 can be utilized to drive network interface 204 for interfacing server 102 to proxy 108 or clients 110 to 114. Device agent module 228 can be utilized to implement the architecture for TCP multiplexing with proxy 108. As noted above, multiple TCP requests can be consolidated from clients 110 to 114 into one TCP connection 106 between proxy 108 and server 102. Other files 230 can contain other files or programs necessary to operate server 102 and/or to provide additional functionality to server 102.

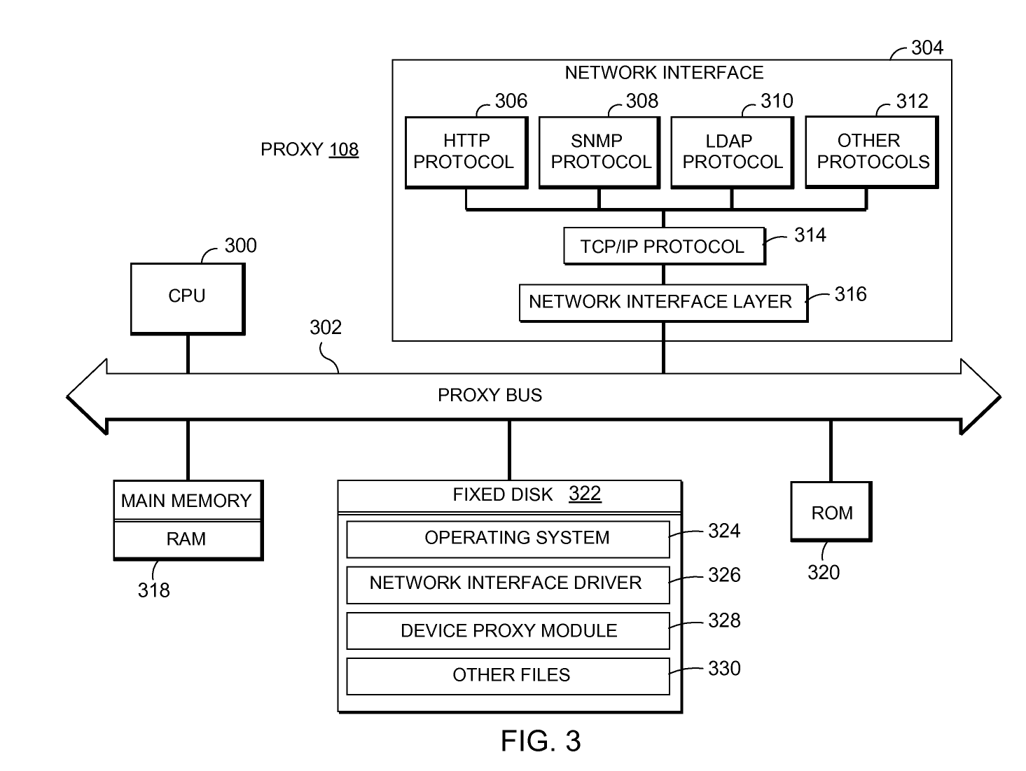

FIG. 3 is a block diagram depicting the internal architecture of the proxy shown in FIG. 1, according to an example embodiment. Proxy 108 can correspond to a component of the port forwarding system to help broker communication between a device and client application. For example, proxy 108 can correspond to a component on the internet. Further, the device can be capable of communicating over a network and can execute the device agent, such as a multi-function printer (MFP). In addition, the device may be separated from proxy 108 and the client application by a firewall.

Although an application from any of clients 110 to 114 can be designed to interact with a device directly, it typically uses proxy 108 to do so, since the application may be running outside of the firewall. As noted above, proxy 108 receives multiple TCP requests from clients 110, 112 and 114, and consolidates the multiple TCP requests into one TCP connection 106 between proxy 108 and a server 102.

As can be seen in FIG. 3, proxy 108 can include a central processing unit (“CPU”) 300 such as a programmable microprocessor which can be interfaced to proxy bus 302. Also coupled to proxy bus 302 can be a network interface 304 for interfacing to server 102 and clients 110 to 114. In addition, random access memory (“RAM”) 318, fixed disk 322, and read-only memory (“ROM”) 320 can be coupled to proxy bus 302. RAM 318 can interface to proxy bus 302 to provide CPU 300 with access to memory storage, thereby acting as a main run-time memory for CPU 300. In particular, when executing stored program instruction sequences, CPU 300 can load those instruction sequences from fixed disk 322 (or other memory media) into RAM 318 and execute those stored program instruction sequences out of RAM 318. It should also be recognized that standard disk-swapping techniques can allow segment of memory to be swapped to and from RAM 318 and fixed disk 322.

Network interface 304 can contain several modules to provide the appropriate interface functionality for proxy 108. For example, network interface 304 can contain network interface layer 316, which is typically a low-level protocol layer. TCP/IP layer 314 can be provided above network interface layer 316 for communicating over a network with server 102 and clients 110 to 114 via TCP/IP. Other protocols 312 can also be provided to allow proxy 108 to communicate to over the network using other conventional protocols. In this regard, it is possible for HTTP protocol 306, SNMP protocol 308, and LDAP protocol 310 to be provided in network interface 304 for allowing proxy 108 to communicate over a network using HTTP, SNMP and LDAP, respectively. However, it should be noted that HTTP, SNMP and LDAP protocols, along with other conventional protocols, can instead be provided by operating system 324. The foregoing protocols can allow for proxy 108 to communicate over a network (e.g., the Internet) with other devices (e.g., server 102 and clients 110 to 114).

Fixed disk 322 is one example of a computer-readable medium that stores program instruction sequences executable by CPU 300 so as to constitute operating system 324, network interface driver 326, device proxy module 328 and other files 330. Operating system 324 can be an operating system such as DOS, Windows 95, Windows 98, Windows 3000, Windows XP, Windows 7, Windows NT, UNIX, or other such operating system. Network interface driver 326 can be utilized to drive network interface 304 for interfacing proxy 108 to server 102 and clients 110 to 114. Device proxy module 328 can be utilized to implement the architecture for consolidating multiple TCP requests from clients (e.g., 110 to 114) into one TCP connection 106 between proxy 108 and server 102. Other files 330 can contain other files or programs necessary to operate proxy 108 and/or to provide additional functionality to proxy 108.

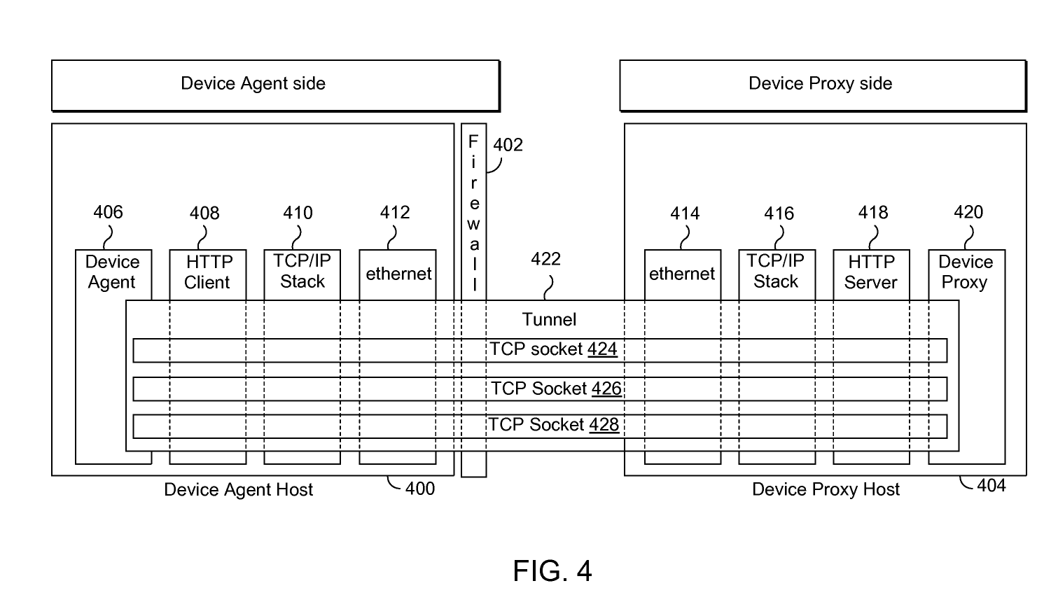

FIG. 4 is a diagram illustrating an example of network communication between a device agent host and a device proxy host according to an example embodiment. For a communication path between a device and an application which requests data from the device, the coordination of tunneling data can occur on both the application side and the device side. Such coordination can be implemented, for example, as software drivers on both the application side and the device side. Of course, such implementation is not limited to software, and hardware can also be used.

With reference to FIG. 4, on the application side, the coordination of tunneling can be handled by a device proxy 420, which is included in device proxy host 404. In this regard, device proxy host 404 can correspond to proxy 108. Device proxy host 404 can also include Ethernet module 414, TCP/IP stack 416 and HTTP server 418. Ethernet module 414 can be part of network interface 304, and can be used by TCP/IP stack 416 to send and receive messages using TCP/IP protocol. TCP/IP stack 416 can be part of TCP/IP protocol 314. HTTP server 418 can use TCP/IP stack 416 to send and receive HTTP messages, and can use HTTP protocol 306 and network interface 304 to implement its services. In addition, HTTP server 418 can utilize TCP/IP stack 416 to provide TCP sockets (e.g., 424 to 428) to device proxy 420.

On the device side, the coordination of tunneling can be handled by a device agent 406, which is included in a device agent host 400. Device agent host 400 can correspond to server 102. TCP multiplexing can occur between device agent 400 and device proxy host 404, and the two hosts can be separated by a firewall 402. In this regard, device agent host can also include http client 408, TCP/IP stack 410 and Ethernet module 412. Ethernet module 412 can be part of network interface 204, and can be used by TCP/IP stack 410 to send and receive messages using TCP/IP protocol. TCP/IP stack 410 can be part of TCP/IP protocol 214. HTTP client 408 can use TCP/IP stack 410 to send and receive HTTP messages, and can use HTTP Protocol 206 and network interface 204 to implement its services. In addition, HTTP client 408 can utilize TCP/IP stack 410 to provide TCP sockets (e.g., 424 to 428) to device proxy 406.

In order to lessen the creation of connections such as HTTP connections, multiple TCP tunnels can be carried over a single connection between device agent host 400 and device proxy host 404. In this regard, device proxy 420 can consolidate multiple TCP requests from clients into one TCP connection (e.g., via tunnel 422) between device proxy host 404 and device agent host 400. Tunnel 422 can include multiple TCP sockets 424, 426 and 428 for communication between device agent host 400 and device proxy host 404. In one example embodiment, tunnel 422 is an HTTP tunnel.

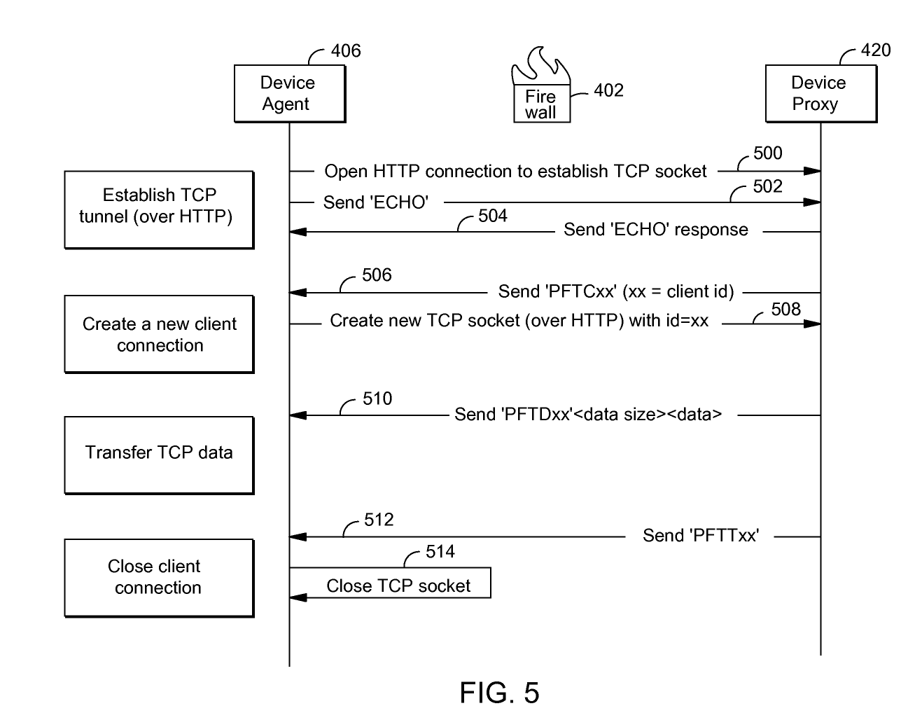

To enable communication between device agent host 400 and device proxy host 404, the data stream tunneled through tunnel 422 can contain leading bytes of information (e.g., in the form of a header) to identify the data and to give direction to the receiver as to how to handle the data. In one example embodiment, the header may direct device agent 406 to create a new connection to device proxy host 404 for a particular client (e.g., client 110 to 114). Because the streams carry identifying information, multiple tunnels can be carried over a single connection via tunnel 422. The use of identifying information will be described in further detail below with reference to FIG. 5.

FIG. 5 is a sequence diagram illustrating different sequences for TCP multiplexing over a proxy according to an example embodiment. These different sequences include establishing a TCP tunnel, creating a new client connection, transferring TCP data, and closing a client connection.

In the examples of FIG. 5, the management of multiple clients over a single HTTP or Hypertext Transfer Protocol Secure (HTTPS) connection is illustrated, and the communication protocol for routing TCP data over such a connection (hereinafter “HTTP(S)”) is shown. Of course, connections other than an HTTP(S) connection can be employed.

A description of the steps for establishing a TCP tunnel will now be described with reference to FIG. 5. At sequence step 500, device agent 406 opens an HTTP(S) connection to device proxy 420, to establish an HTTP(S)-based tunnel. At sequence step 502, after an initial HTTP specific handshake, device agent 406 sends an “ECHO” message (e.g., a 4-byte message) to device proxy 420, to indicate that device agent 406 is ready to communicate. At sequence step 504, if device proxy 420 receives an “ECHO” from device agent 406, device proxy 420 responds with an “ECHO” to indicate that device agent 406 can start listening for actual packets of data.

A description of the steps for creating a new client connection will now be described with reference to FIG. 5. When device proxy 420 detects a new client connection, it can assign a 2-character unique identifier to this client connection. The first character of the identifier can be ‘c’, and the second character can be a 1-byte number. This allows up to 256 clients to be connected to a single device socket at any given time. Of course, different configurations for identifiers can be used.

For example, at sequence step 506, device proxy 420 sends the following packet to device agent 406:

PFTC<client id>

In this example, PFTC indicates the request to create a new connection, and <client id> is the 2-character client identifier. At sequence step 508, once device agent 406 receives the above packet, device agent 406 creates a new TCP socket to device proxy 420 and assigns that socket to the above client identifier.

A description of the steps for transferring TCP data will now be described with reference to FIG. 5. At sequence step 510, after a connection is established, available TCP data can be transferred between device proxy 420 and device agent 046 using the following format:

PFTD<client id><data size><data>

In this example, PFTD indicates the request to transfer data, <client id> is the 2-character client identifier, <data size> is a 4-digit integer that indicates the number of bytes of attached data to read, and <data> is the actual TCP data to send to the destination.

A description of the steps for closing a client connection will now be described with reference to FIG. 5. At sequence step 512, the request to close a connection is sent from device proxy host 420 to device agent 406 in the following format:

PFTT<client id>

In this example, PFTT indicates the request to terminate an existing connection, and <client id> is the 2-character client identifier whose connection should be closed.

At sequence step 514, once the request is received, the open TCP socket should be closed. In this regard, to close the TCP tunnel, device proxy 420 closes the tunnel on device proxy 420 end, and device agent 406 closes the corresponding HTTP(S) connection to the device proxy 420.

Thus, TCP multiplexing can be performed over a proxy, where the proxy consolidates multiple TCP requests from clients into one TCP connection between the proxy and a server. In the example of FIG. 5, the proxy can correspond with device proxy 420 and the server can correspond with device agent 400.

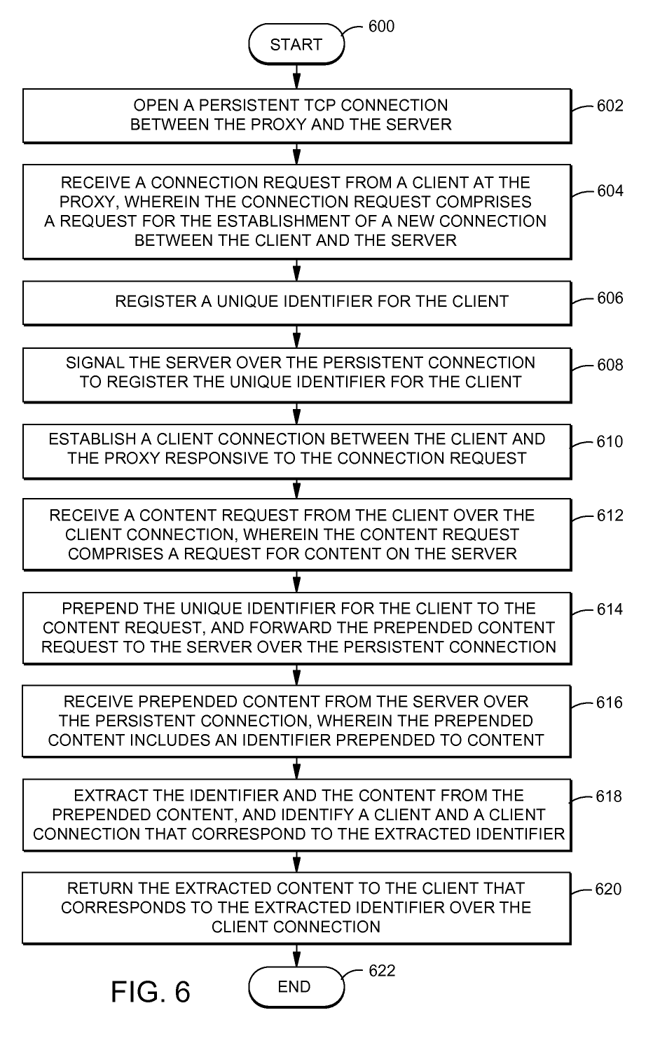

FIG. 6 is a flow diagram further illustrating TCP multiplexing over a proxy, where the proxy consolidates multiple TCP requests from clients into one TCP connection between the proxy and a server.

Following start bubble 600, a persistent TCP connection is opened between the proxy and the server (block 602). A connection request is received from a client at the proxy, wherein the connection request comprises a request for establishment of a new connection between the client and the server (block 604), and a unique identifier is registered for the client (block 606).

The server is signaled over the persistent connection to register the unique identifier for the client (block 608), and a client connection is established between the client and the proxy responsive to the connection request (block 610). A content request is received from the client over the client connection, wherein the content request comprises a request for content on the server (block 612).

The unique identifier for the client is prepended to the content request, and the prepended content request is forwarded to the server over the persistent connection (block 614). Prepended content is received from the server over the persistent connection, wherein the prepended content includes an identifier prepended to content (block 616).

The identifier and the content are extracted from the prepended content, and a client and a client connection are identified that correspond to the extracted identifier (block 618). The extracted content is returned to the client that corresponds to the extracted identifier over the client connection (block 620). The process ends (end bubble 622).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for TCP multiplexing over a proxy, wherein the proxy consolidates multiple TCP requests from clients into one TCP connection between the proxy and a server, the method comprising the steps of:
opening a persistent TCP connection between the proxy and the server;
receiving a connection request from a client at the proxy, wherein the connection request comprises a request for establishment of a new connection between the client and the server;
registering a unique identifier for the client;
signaling the server over the persistent connection to register the unique identifier for the client;
establishing a client connection between the client and the proxy responsive to the connection request;
receiving a content request from the client over the client connection, wherein the content request comprises a request for content on the server;
prepending the unique identifier for the client to the content request, and forwarding the prepended content request to the server over the persistent connection;
receiving prepended content from the server over the persistent connection, wherein the prepended content includes an identifier prepended to content;
extracting the identifier and the content from the prepended content, and identifying a client and a client connection that correspond to the extracted identifier; and
returning the extracted content to the client that corresponds to the extracted identifier over the client connection.

2. A method according to claim 1, wherein the step of opening the persistent TCP connection between the proxy and the server comprises exchanging an ECHO command between the server and the proxy.

3. The method according to claim 1, wherein the server and the proxy are separated by a firewall which exposes the proxy to incoming connection requests and which shields the server from such requests, and wherein the step of opening the persistent TCP connection between the proxy and the server comprises receipt of an ECHO command from the server and a response thereto from the proxy.

4. A method according to claim 1, the method further comprising the step of closing the persistent connection between the server and the proxy.

5. A method according to claim 1, the method further comprising the step of composing a command sequence which includes a command to register the client and the unique identifier of the client, wherein the step of signaling the server comprises sending the command sequence over the persistent connection to the server.

6. A method according to claim 1, the method further comprising the step of composing a command sequence which includes a command to request content, the unique identifier of the client, and the content request from the client, wherein the step of forwarding the prepended content request comprises sending the command sequence to the server.

7. A method according to claim 1, the method further comprising the step of receiving a request from the client to close the client connection.

8. A method according to claim 7, wherein responsive to the request from the client to close the client connection, the method further comprises the steps of:
unregistering the client and its unique identifier; and
signaling the server over the persistent connection to unregister the unique identifier.

9. A proxy which consolidates multiple TCP requests from clients into one TCP connection between the proxy and a server, the proxy comprising:
a computer-readable memory constructed to store computer-executable process steps; and
a processor constructed to execute the computer-executable process steps stored in the memory;
wherein the process steps stored in the memory cause the processor to perform TCP multiplexing, and wherein the process steps stored in the memory include computer-executable steps to:
open a persistent TCP connection between the proxy and the server;
receive a connection request from a client at the proxy, wherein the connection request comprises a request for establishment of a new connection between the client and the server;
register a unique identifier for the client;
signal the server over the persistent connection to register the unique identifier for the client;
establish a client connection between the client and the proxy responsive to the connection request;
receive a content request from the client over the client connection, wherein the content request comprises a request for content on the server;
prepend the unique identifier for the client to the content request, and forward the prepended content request to the server over the persistent connection;
receive prepended content from the server over the persistent connection, wherein the prepended content includes an identifier prepended to content;
extract the identifier and the content from the prepended content, and identify a client and a client connection that correspond to the extracted identifier; and
return the extracted content to the client that corresponds to the extracted identifier over the client connection.

10. A proxy according to claim 9, wherein the process step to open the persistent TCP connection between the proxy and the server comprises exchanging an ECHO command between the server and the proxy.

11. The proxy according to claim 9, wherein the server and the proxy are separated by a firewall which exposes the proxy to incoming connection requests and which shields the server from such requests, and wherein the step to open the persistent TCP connection between the proxy and the server comprises receipt of an ECHO command from the server and a response thereto from the proxy.

12. A proxy according to claim 9, the process steps stored in the memory further including computer-executable steps to close the persistent connection between the server and the proxy.

13. A proxy according to claim 9, the process steps stored in the memory further including computer-executable steps to compose a command sequence which includes a command to register the client and the unique identifier of the client, wherein the step to signal the server comprises sending the command sequence over the persistent connection to the server.

14. A proxy according to claim 9, the process steps stored in the memory further including computer-executable steps to compose a command sequence which includes a command to request content, the unique identifier of the client, and the content request from the client, wherein the step to forward the prepended content request comprises sending the command sequence to the server.

15. A proxy according to claim 9, the process steps stored in the memory further including computer-executable steps to receive a request from the client to close the client connection.

16. A proxy according to claim 15, wherein responsive to the request from the client to close the client connection, the process steps stored in the memory further including computer-executable steps to:
unregister the client and its unique identifier; and
signal the server over the persistent connection to unregister the unique identifier.

17. A computer-readable memory medium on which is stored computer-executable process steps for causing a computer to perform TCP multiplexing over a proxy, wherein the proxy consolidates multiple TCP requests from clients into one TCP connection between the proxy and a server, the process steps comprising:
opening a persistent TCP connection between the proxy and the server;
receiving a connection request from a client at the proxy, wherein the connection request comprises a request for establishment of a new connection between the client and the server;
registering a unique identifier for the client;
signaling the server over the persistent connection to register the unique identifier for the client;
establishing a client connection between the client and the proxy responsive to the connection request;
receiving a content request from the client over the client connection, wherein the content request comprises a request for content on the server;
prepending the unique identifier for the client to the content request, and forwarding the prepended content request to the server over the persistent connection;
receiving prepended content from the server over the persistent connection, wherein the prepended content includes an identifier prepended to content;
extracting the identifier and the content from the prepended content, and identifying a client and a client connection that correspond to the extracted identifier; and
returning the extracted content to the client that corresponds to the extracted identifier over the client connection.

18. A method for a server to communicate with a proxy, wherein the proxy consolidates multiple TCP requests from clients into one TCP connection between the proxy and the server, the method comprising the steps of:
opening a persistent TCP connection between the proxy and the server;
receiving a signal over the persistent connection to register a unique identifier for a client, based on a connection request from the client at the proxy, wherein the connection request comprises a request for establishment of a new connection between the client and the server;
registering the unique identifier for the client based on the signal;
receiving a content request from the proxy over the persistent connection, wherein a client connection is established between the client and the proxy responsive to the connection request, the content request is received by the proxy from the client over the client connection, the content request comprises a request for content on the server, and the content request is prepended with the unique identifier for the client;
obtaining content based on the prepended content request;
prepending an identifier to the obtained content;
sending the prepended content to the proxy over the persistent connection, for extraction of the identifier and the content from the prepended content, identification of a client and a client connection corresponding to the extracted identifier, and return of the extracted content to the client that corresponds to the extracted identifier over the client connection.

19. A server comprising:
a computer-readable memory constructed to store computer-executable process steps; and
a processor constructed to execute the computer-executable process steps stored in the memory;
wherein the process steps stored in the memory cause the processor to communicate with a proxy which consolidates multiple TCP requests from clients into one TCP connection between the proxy and the server, and wherein the process steps stored in the memory include computer-executable steps to:
open a persistent TCP connection between the proxy and the server;
receive a signal over the persistent connection to register a unique identifier for a client, based on a connection request from the client at the proxy, wherein the connection request comprises a request for establishment of a new connection between the client and the server;
register the unique identifier for the client based on the signal;
receive a content request from the proxy over the persistent connection, wherein a client connection is established between the client and the proxy responsive to the connection request, the content request is received by the proxy from the client over the client connection, the content request comprises a request for content on the server, and the content request is prepended with the unique identifier for the client;
obtain content based on the prepended content request;
prepend an identifier to the obtained content;
send the prepended content to the proxy over the persistent connection, for extraction of the identifier and the content from the prepended content, identification of a client and a client connection corresponding to the extracted identifier, and return of the extracted content to the client that corresponds to the extracted identifier over the client connection.

20. A computer-readable memory medium on which is stored computer-executable process steps for causing a computer to perform communication with a proxy, wherein the proxy consolidates multiple TCP requests from clients into one TCP connection between the proxy and a server, the process steps comprising:
opening a persistent TCP connection between the proxy and the server;
receiving a signal over the persistent connection to register a unique identifier for a client, based on a connection request from the client at the proxy, wherein the connection request comprises a request for establishment of a new connection between the client and the server;
registering the unique identifier for the client based on the signal;
receiving a content request from the proxy over the persistent connection, wherein a client connection is established between the client and the proxy responsive to the connection request, the content request is received by the proxy from the client over the client connection, the content request comprises a request for content on the server, and the content request is prepended with the unique identifier for the client;
obtaining content based on the prepended content request;
prepending an identifier to the obtained content;
sending the prepended content to the proxy over the persistent connection, for extraction of the identifier and the content from the prepended content, identification of a client and a client connection corresponding to the extracted identifier, and return of the extracted content to the client that corresponds to the extracted identifier over the client connection.
